(19) United States
(12) Patent Application Publication
(10) Pub. No.: US 2012/0326423 A1
(43) Pub. Date: Dec. 27, 2012

(54) FILTER FOR PYROTECHNIC AIRBAG INFLATOR

(76) Inventor: Isaac Hoffman, Kaysville, UT (US)

(21) Appl. No.: 13/167,055

(22) Filed: Jun. 23, 2011

(51) Int. Cl. B60R 21/26; B23P 11/00; B01D 50/00

(52) U.S. Cl. 280/741; 55/385.3; 29/428

(57) ABSTRACT

A filter element made up of a plurality of substantially spaced-apart barriers that afford fluid communication between a source of pressurized airbag inflation gas containing entrained particulates and an airbag inflation gas entry port. The inflation gas and entrained debris pass along a tortuous path of back-and-forth oppositely-directed gas flow pathways between successive pairs of adjacent of the barriers. An aperture is formed through each of the barriers, and the barriers are so arranged that the aperture in a selected barrier is remote from the aperture in any barrier adjacent thereto. A debris pocket at an end of one of the gas flow pathways is so configured that particulates entrained in inflation gas collect in the debris pocket sheltered from sustained entrainment in the outflow of inflation gas.

### BACKGROUND OF THE INVENTION

1. Field of the Invention

The present invention pertains to maintaining the safety of riders in highway vehicles. More particularly, the present invention pertains to the removal of debris from the pressurized gas used to inflate the passenger vehicle safety airbags that are intended to protect a rider from impact with the interior of the occupant enclosure of a vehicle.

2. Background

Inflatable safety restraint devices, or airbags, are mandated in most new highway vehicles. Airbags are typically included at least in the steering wheel and in the dashboard on the passenger side of a highway vehicle. In addition, such airbags are occasionally installed to inflate beside a vehicle occupant and provide side impact protection, to inflate in front of the legs and protect the knees from forward impact, or to inflate at other strategic locations within the occupant enclosure of a highway vehicle.

In the event of an accident, a collision sensor within the vehicle detects an impact situation and stimulates an inflator to produce pressurize gas. That pressurized gas is directed into an associated airbag, filling the cushion of the airbag, which then prevents a vehicle rider from impacting directly the interior surfaces of the occupant enclosure. The generation of compressed gas occurs in a combustion chamber in the inflator and is commenced typically through the electrical detonation of a small pyrotechnic initiator within the combustion chamber. Inflatable airbags with associated inflators and initiators are usually manufactured together as passenger vehicle safety airbag modules, which are installed unit-wise at appropriate locations in vehicles.

A passenger-side, frontal-impact passenger vehicle safety airbag module is commonly installed behind the instrument panel of a vehicle at an airbag deployment window formed therethrough. The initiator in the inflator of the module is placed in electrical communication with the collision sensor of the vehicle.

Pressurized inflation gas leaving the combustion chamber of an initiator often entrains undesirable particulate debris produced by the pyrotechnic processes in the combustion chamber that gave rise to the inflation gas. This debris can potentially cause damage to the airbag into which the inflation gas is directed. Accordingly, passenger vehicle safety airbag modules routinely make provisions for the removal of such debris from pressurized inflation gas before it leaves the inflator and enters the cushion of the airbag in the module.

### BRIEF SUMMARY OF THE INVENTION

According to teachings of the present invention, solids are removed from a stream of pressurized inflation gas by forcing the inflation gas into several sharp changes in direction before the inflation gas leaves the inflator in which it is created.

In one aspect to the present invention, a filter element is made up of a plurality of substantially parallel-disposed barriers that afford fluid communication between a source of pressurized airbag inflation gas containing entrained particulates and an airbag inflation gas entry port along a tortuous path of back-and-forth oppositely-directed gas flow pathways between adjacent barriers. An aperture is formed through each of the barriers, and the barriers are so arranged that the aperture in a selected barrier is remote from and non-aligned with the aperture in any barrier adjacent thereto. A debris pocket at an end of one of the gas flow pathways is so configured that particulates entrained in inflation gas collect in the debris pocket sheltered from sustained entrainment in the outflow of inflation gas.

According to another aspect of the present invention, a filter for an airbag module inflator includes a plurality of spaced-apart cylindrical barriers of increasing diameter, substantially concentric or eccentric, secured at the opposed ends thereof within the inflator in a narrowly-spaced coaxial relationship about the combustion chamber of the inflator. Formed through each of the barriers proximate to a preselected end thereof is a plurality of apertures, but the barriers are so arranged within the inflator that the apertures in a selected barrier are remote from and non-aligned with the apertures in any barrier adjacent thereto. In this manner, inflation gas from the combustion chamber is required to travel to an outlet port of the inflator along a tortuous path of oppositely-directed gas flow pathways between adjacent pairs of the barriers.

In yet another aspect of the present invention, a filter is provided for removing debris from inflation gas pyrotechnically generated in the combustion chamber of the inflator of a passenger vehicle safety airbag module. The inflator has a discharge port through which the inflation gas flows into the cushion of the airbag module. In the filter is a first barrier secured within the inflator across the flow of inflation gas from the combustion chamber to the discharge port having a first aperture formed therethrough proximate to an edge thereof. A second barrier having a second aperture formed therethrough proximate to an edge thereof is secured within the inflator across the flow of inflation gas from the first aperture to the discharge port with the second aperture disposed remote from and non-aligned with the first aperture. A third barrier having a third aperture formed therethrough is secured within the inflator across the flow of inflation gas from the second aperture to the discharge port with the third aperture disposed remote from and non-aligned with the second aperture. The third aperture is formed through the third barrier proximate to an edge thereof.

The first, second, and third barriers may each be a respective wall of sheet metal. In one exemplary embodiment, the first, second, and third barriers are cylindrical walls secured at the open ends thereof within the inflator enclosing the combustion chamber. The barriers may be coaxially disposed about the combustion chamber. However, it should be understood that two or more of the barriers may also be concentric or eccentric to create a desired gas flow.

A first passageway is defined between the first barrier and the second barrier. In operation, and a second passageway is defined between the second barrier and the third barrier. The first passageway contains inflation gas flowing from the first aperture to the second aperture, while the second passageway contains inflation gas flowing in a direction generally opposite to the flow of inflation gas in the first passageway. Proximate the end of the first passageway at the second aperture is a first debris collection pocket, while proximate the end of the second passageway at the third aperture is a second debris collection pocket. Inflation gas flowing through the first aperture is directed generally normal to a surface of the second barrier, inflation gas flowing through the second aperture is directed generally normal to a surface of the third barrier, and inflation gas flowing through the third aperture is directed perpendicularly to the interior of the inflator at a location other than the location of the discharge port.

Also provided according to teachings of the present invention is an inflator for a passenger vehicle safety airbag module. The inflator includes a sturdy casing enclosing a combustion chamber, an exit port formed through the casing, and a filter as described above that is capable of removing debris from inflation gas pyrotechnically generated in the combustion chamber.

The present invention includes a method for removing debris from pressurized inflation gas generated in the combustion chamber of the inflator of a passenger vehicle safety airbag module. In the method, the combustion chamber of the inflator is encircled with a plurality of cylindrical barriers of increasing diameter disposed in a narrowly-spaced coaxial relationship with each other, and through each of the barriers proximate to a preselected end thereof is formed a plurality of apertures. The barriers are secured at the opposed ends thereof within the inflator, and the barriers are arranged within the inflator in such a manner that the apertures in a selected barrier are remote from the apertures in any barrier adjacent thereto. A discharge port for the inflator is positioned in such a location that inflation gas traveling through the apertures in the radially-outermost of the barriers is directed into a perpendicular impact against the interior of the inflator at a location other than the location of the discharge port.

### BRIEF DESCRIPTION OF THE SEVERAL VIEWS OF THE DRAWINGS

In order that the manner in which the above-recited and other features and advantages of the present invention are obtained will be readily understood, a more particular description of the present invention briefly described above will be rendered by reference to specific embodiments thereof which are illustrated in the appended drawings. Understanding that these drawings depict only typical embodiments of the present invention and are not therefore to be considered to be limiting of scope thereof, the present invention will be described and explained with additional specificity and detail through the use of the accompanying drawings in which:

FIG. 1 is a side elevational view of a passenger vehicle safety airbag module incorporating teachings of the present invention mounted as a passenger-side, frontal-impact protection feature on the instrument panel of a highway vehicle and deployed into the occupant enclosure with the cushion of the airbag in an inflated condition;

FIG. 2 is a view in partial cross section of the energizer section of the passenger vehicle safety airbag module of FIG. 1 revealing therewithin an embodiment of an inflator incorporating teachings of the present invention;

FIG. 3 is a cross-sectional plan view of the inflator of FIG. 2 revealing therewithin an embodiment of a filter incorporating teachings of the present invention for the purpose of removing debris from pressurized inflation gas pyrotechnically generated in the combustion chamber of the inflator;

FIG. 4 is a cross-sectional elevational view of the inflator of FIG. 2 revealing aspects of the filter incorporating teachings of the present invention shown in FIG. 3;

FIG. 5 is an enlarged cross-sectional elevational view of a portion of the inflator of FIG. 4;

FIG. 6 is a first schematic diagram illustrating patterns of flow arising in the filter of FIG. 5 when pressurized inflation gas passes therethrough;

FIG. 7 is a second schematic diagram of patterns of flow arising in the filter of FIG. 5;

FIG. 8 is a cross-sectional elevational view of a portion of a second embodiment of a filter incorporating teachings of the present invention;

FIG. 9 is a cross-section elevational view of a portion of a third embodiment of a filter incorporating teachings of the present invention;

FIG. 10 is a cross-sectional view of a portion of a fourth embodiment of a filter incorporating teachings of the present invention; and

FIG. 11 is a cross-sectional elevation view of a fifth embodiment of a filter incorporating teachings of the present invention.

### DETAILED DESCRIPTION OF THE INVENTION

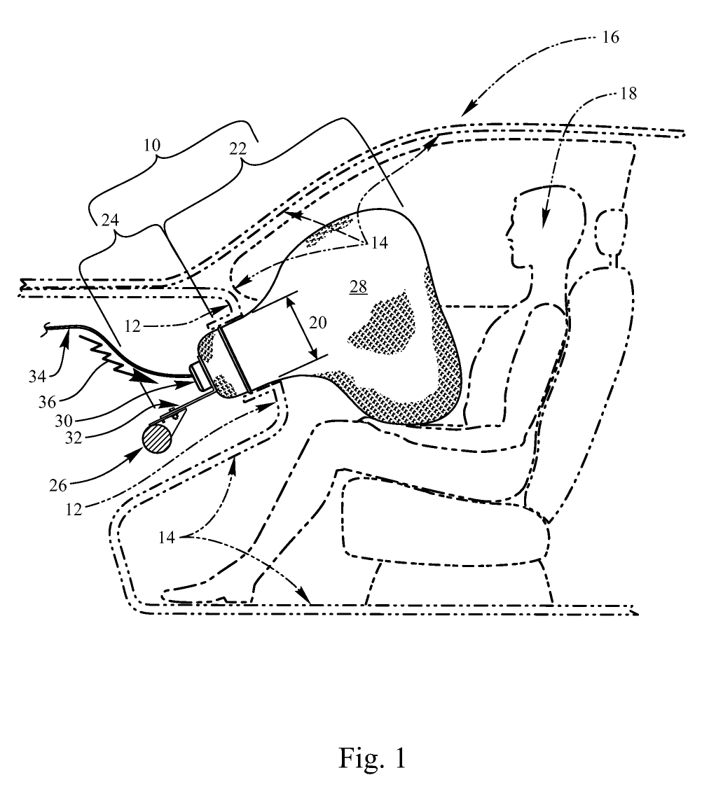

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in FIGS. 1-11, is not intended to limit the scope of the invention, as claimed, but is merely representative of presently preferred embodiments of the invention.

In this application, the phrases “connected to”, “coupled to”, and “in communication with” refer to any form of interaction between two or more entities, including mechanical, electrical, magnetic, electromagnetic, pneumatic, and thermal interactions.

The phrases “attached to”, “secured to”, and “mounted to” refer to a form of mechanical coupling that restricts relative translation or rotation between the attached, secured, or mounted object, respectively. The phrases “pivotally attached to” and “slidably attached to” refer to forms of mechanical coupling that permit relative rotation or relative translation, respectively, while restricting other relative motions. The phrase “attached directly to” refers to a form of securement in which the secured items are in direct contact and retained in that state of securement without resort to fasteners or adhesives.

The term “abutting” refers to items that are in direct physical contact with each other, although the items may not be attached together. The term “grip” refers to items that are in direct physical contact with one of the items firmly holding the other. The term “integrally formed” refers to a body that is manufactured as a single piece, without requiring the assembly of constituent elements. Multiple elements may be integrally formed with each other, when developed attached directly to each other from a single work piece. Thus, elements that are “coupled to” each other may be formed together as a single piece.

It should be understood that the teachings of the present invention have applicability, not only to passenger-side, frontal-impact protection, but also to other forms of passenger protection, such as knee bolsters, driver-side airbags, overhead airbags, inflatable curtains, side airbags, inflatable structural stiffeners, and the like. Consequently, although a passenger-side airbag is disclosed and described herein, the term “passenger vehicle safety airbag” includes these other forms of passenger protection. Furthermore, the teachings of the present invention may be employed advantageously, not only in highway vehicles, but also in vehicles that travel over rails, from cables, on water, and through air or space.

FIG. 1 is a side elevation view of an embodiment of a vehicle passenger safety airbag module 10 incorporating teachings of the present invention and mounted as a passenger-side, frontal-impact protection feature at the instrument panel 12 of the occupant enclosure 14 of a highway vehicle 16. Airbag module 10 provides protection to a rider 18 seated within occupant enclosure 14 by precluding, for example, the head or legs of rider 18 from impacting the interior of occupant enclosure 14 during a collision involving vehicle 16.

Airbag module 10 is installed in vehicle 16 at an airbag deployment window 20 formed through instrument panel 12. As shown by way of example and not limitation, airbag module 10 in FIG. 1 is mounted outside of occupant enclosure 14 in proximity to deployment window 20. Alternatively, an airbag module, such as airbag module 10, may be installed in a mounting recess formed in a side of occupant enclosure 14 that faces rider 18. In such instances, the mouth of the mounting recess also faces rider 18 and functions as an airbag deployment window in the same manner as deployment window 20.

By way of overview, airbag module 10 includes a deployment section 22 that is secured to instrument panel 12 at deployment window 20 and an energizer section 24 that is supported independently from deployment section 22 on a structural element 26 of vehicle 16. Deployment section 22 includes a gas-inflatable, impact-absorbing cushion 28.

Energizer section 24 of airbag module 10 is manufactured in inflation communication with deployment section 22. Energizer section 24 generates and delivers pressurized gas to deployment section 22, when an impact is imminent between rider 18 and occupant enclosure 14. Toward that end, energizer section 24 includes an inflator 30 incorporating teachings of the present invention that produces the pressurized gas for cushion 28 and a mounting bracket 32 secured to inflator 30 by which inflator 30 is supported from structural element 26 of vehicle 16. Inflator 30 may be, for example, a compressed gas inflator, a pyrotechnic inflator, a hybrid inflator, or any other type of device that generates pressurized gas with extreme dispatch. The activation of inflator 30 is triggered electrically, but indirectly, by way of a pyrotechnic initiator that is not visible in FIG. 1.

An electrical wire 34 is coupled between the initiator of inflator 30 and the collision sensor for vehicle 16. When an impact involving vehicle 16 is occurring or is about to occur, the collision sensor generates an activation signal 36 that is transmitted along electrical wire 34 to trigger activity in inflator 30. Inflator 30 then produces an abundance of pressurized inflation gas that is communicated into deployment section 22 of airbag module 10, filling cushion 28 to capacity and causing cushion 28 to extend through deployment window 20 into occupant enclosure 14 intermediate rider 18 and instrument panel 12 as shown.

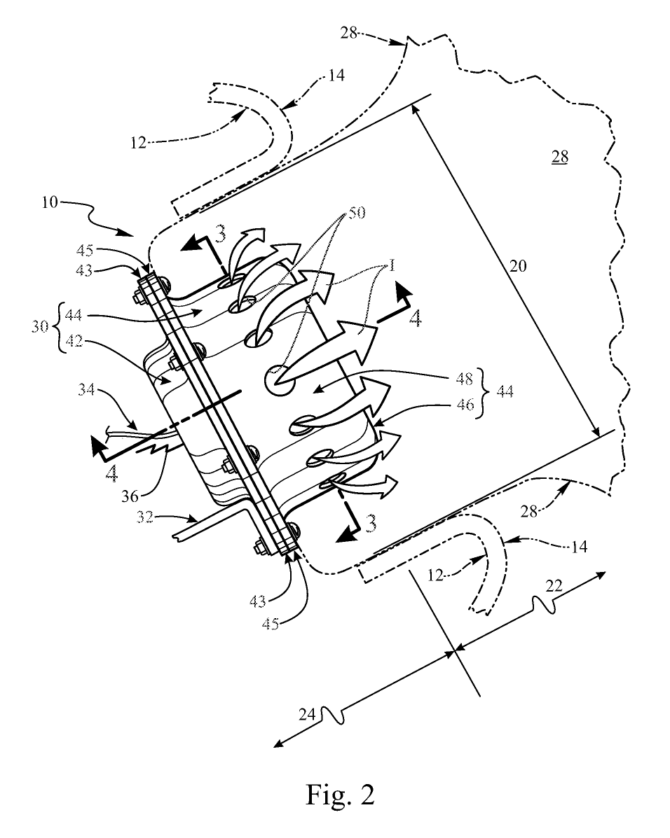

FIG. 2 is a view in partial cross section of energizer section 24 of airbag module 10 from FIG. 1. Inflator 30 of energizer section 24 incorporates teachings of the present invention and is supported by mounting bracket 32 in the vicinity of deployment window 20, while deployment section 22 of airbag module 10 is attached to instrument panel 12 within deployment window 20. Pressurized inflation gas I produced in inflator 30 is communicated from inflator 30 to deployment section 22 of airbag module 10, filling cushion 28 thereof, which projects through deployment window 20 into the interior of occupant enclosure 14. The mounting and support of the sections of a vehicle passenger safety airbag module, such as airbag module 10, in relation to the occupant enclosure of a vehicle 16 can vary from the specific details depicted in FIG. 2 without departing from the principles of the present invention.

By way of example, inflator 30 includes a sturdy base 42 with an encircling flange 43 joined to a correspondingly sturdy dome 44 having an encircling flange 45. Dome 44 has a substantially planar ceiling 46 and a continuous encircling sidewall 48 that interconnects the periphery of ceiling 46 to flange 45. Through sidewall 48 are formed a plurality of exit ports 50 from which pressurized inflation gas I emerges from inflator 30 to fill cushion 28.

Whether inflator 30 is a compressed gas inflator, a pyrotechnic inflator, a hybrid inflator, or any other type of device that generates pressurized gas with extreme dispatch, the production of inflation gas I is not stimulated directly by activation signal on electrical wire 34. Instead, the activity of inflator 30 in producing inflation gas I is commenced by an igniter that is secured within base 42 and dome 44 of inflator 30 and is thus not visible in FIG. 2.

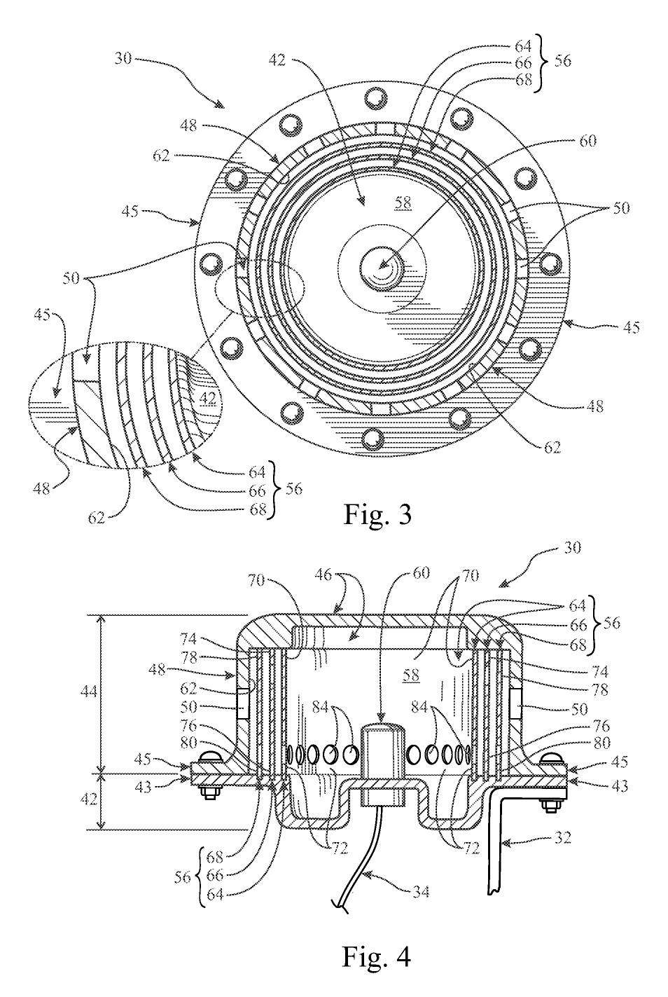

FIGS. 3 and 4 are cross-sectional views of inflator 30 that taken together advantageously depicts structural aspects of a first embodiment of a filter 56 incorporating teachings of the present invention and secured within inflator 30 closely spaced from inner surface 62 of sidewall 48 of dome 44. The elements of filter 56, which will be described in substantial detail subsequently, are disposed about a combustion chamber 58. At the center of combustion chamber 58 is located an igniter 60 that stimulates the commencement of the production of pressurized inflation gas in combustion chamber 58. Inflation gas from combustion chamber 58 leaves inflator 30 by way of exit ports 50, in the process passing through filter 56.

As understood most readily by reference to FIG. 3, filter 56 includes a plurality of cylindrical barriers disposed in a narrowly-spaced coaxial relationship about combustion chamber 58 and igniter 60. By way of example and not limitation, the barriers of filter 56 include a cylindrical inner barrier 64 encircling combustion chamber 58 immediately adjacent thereto, an intermediate barrier 66 of slightly larger-diameter positioned in a narrowly-spaced substantially coaxial relationship encircling inner barrier 64, and an even larger-diameter outer barrier 68 positioned in a narrowly-spaced substantially coaxial relationship about intermediate barrier 66. In FIG. 3, these elements of filter 56 are relatively thin, circumferentially continuous structures constructed, by way of example, from stainless steel sheeting.

By reference to FIG. 4, it can be appreciated, however, that each of inner barrier 64, intermediate barrier 66, and outer barrier 68 terminate axially in opposed circular edges that are secured, respectively, within base 42 and dome 44 of inflator 30. Thus, inner barrier 64 has an upper edge 70 that is secured in ceiling 46 of dome 44 and a lower edge 72 that is secured in base 42. Intermediate barrier 66 has an upper edge 74 secured in ceiling 46 of dome 44 and a lower edge 76 secured in base 42, while outer barrier 68 has an upper edge 78 secured in ceiling 46 of dome 44 and a lower edge 80 secured in base 42. In this manner, inner barrier 64, intermediate barrier 66, and outer barrier 68 of filter 56 is each disposed across any flow of pressurized inflation gas from combustion chamber 58 to exit ports 50.

Once secured in inflator 30, the barriers of filter 56, despite having opposed ends that are open, can for convenience be described as enclosing combustion chamber 58. Inner barrier 64, intermediate barrier 66, and outer barrier 68 do nonetheless afford a controlled degree of fluid communication between combustion chamber 58 and exit ports 50 of inflator 30, because one or more carefully located apertures is formed through each. For example, as seen in FIG. 4, a plurality of first apertures 84 is formed through inner barrier 64 proximate to lower edge 72 thereof. Similar apertures are formed at contrasting locations through intermediate barrier 66 and outer barrier 68, but these apertures are positioned in such a manner that the apertures through any one of the barriers of filter 56 are remote from the aperture or apertures in any barrier adjacent thereto.

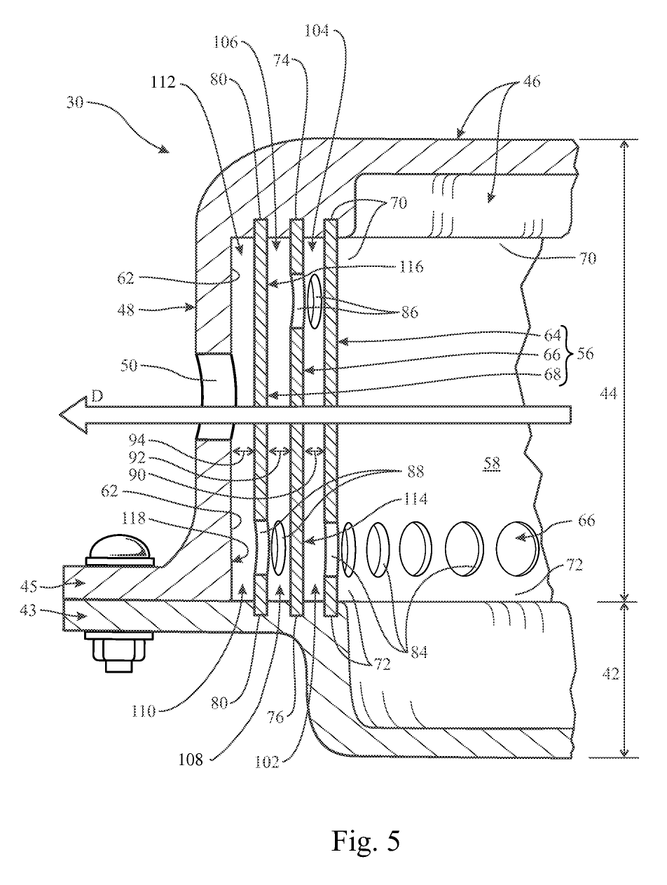

The apertures formed through intermediate barrier 66 and outer barrier 68 are shown in enhanced detail in the enlarged cross-sectional view of a single side of inflator 30 presented in FIG. 5. There, first apertures 84 formed through inner barrier 64 continue to be located proximate to lower edge 72 thereof. A plurality of second apertures 86 is formed through intermediate barrier 66 proximate to upper edge 74 thereof, remote from first apertures 64. A plurality of third apertures 88 is formed through outer barrier 68 proximate to lower edge 80 thereof, remote from second apertures 86 in intermediate barrier 66.

The effect of filter 56 on the outflow of pressurized inflation gas from combustion chamber 58 in inflator 30 is to prevent pressurized inflation gas from flowing directly therebetween in the manner suggested in FIG. 5 by arrow D. Instead, fluid communication is afforded between combustion chamber 58 and exit ports 50 only along a tortuous path of back-and-forth, oppositely-directed gas flow pathways between successive pairs of the barriers of filter 56.

For example, between inner barrier 64 and intermediate barrier 68 is a cylindrical first passageway 90 that extends longitudinally between base 42 and ceiling 46 of dome 44 of inflator 30. Pressurized gas from combustion chamber 58 enters first passageway 90 through first apertures 84 in inner barrier 64 close to base 42 of inflator 30. In order to exit first passageway 90, however, any such pressurized inflation gas must traverse the length of first passageway 90 toward ceiling 46 and leave first passageway 90 by way of second apertures 86 that are formed through intermediate barrier 66 in the vicinity of ceiling 46. Upon passing through second apertures 86, pressurized inflation gas enters a second passageway 92 between intermediate barrier 66 and outer barrier 68. Second passageway 92 is a cylindrical space of a diameter slightly larger than the diameter of first passageway 90, but both first passageway 90 and second passageway 92 are bounded at the opposite ends thereof, respectively, by base 42 and ceiling 46 of dome 44 of inflator 30. Pressurized inflation gas in second passageway 92 escapes therefrom by traveling the length thereof toward base 42 of inflator 30 and passing through third apertures 88 in outer barrier 68 close to base 42. In so doing, the pressurized inflation gas in second passageway 92 travels in an opposite direction from the direction of flow of inflation gas in first passageway 90. Passing through third apertures 88, pressurized inflation gas enters a third passageway 94 between outer barrier 68 and the inner surface 62 of sidewall 48 of dome 44. Upon entering third passageway 94, pressurized inflation gas reverses its direction of flow once again, traveling toward ceiling 46 of dome 44 at least until reaching exit ports 50, where the pressurized inflation gas is able to leave inflator 30 and enter cushion 28 of airbag module 10 as shown in FIG. 1.

The filtering effect on pressurized inflation gas of this complex flow pattern deserves examination. Initially, inflation gas passes through first apertures 84 and is directed straight at inner barrier 66 in what for convenience herein will be described as a substantially perpendicular impact. The inflation gases then veer from that substantially perpendicular impact along first passageway 90 toward second apertures 86, but the momentum of any debris entrained in the inflation gas brings that debris into a substantially perpendicular impact with intermediate barrier 66, where the debris loses momentum and either adheres against intermediate barrier 66 or may migrate out of the flow of inflation gas into a first debris pocket 102 below first apertures 84 against base 42 of inflator 30 between inner barrier 64 and intermediate barrier 66. This action is similar in some respects to the manner in which dust is removed from rotating gas in a cyclone separator.

Debris still remaining entrained in pressurized gas flowing in first passageway 90 is driven against ceiling 46 of dome 44 between inner barrier 64 and intermediate barrier 66, while the entraining inflation gas makes a ninety-degree turn to pass through second apertures 86. The space between inner barrier 64 and intermediate barrier 66 at ceiling 46 of dome 44 thus also collects debris, functioning as a second debris pocket 104. Inflation gas entering second passageway 92 through second apertures 86 is driven directly against the solid wall of outer barrier 68. The inflation gas rapidly changes direction, but the momentum of entrained debris brings it into impact against outer barrier 68 causing the debris to adhere thereto or it may to migrate into the relatively unturbulent space between intermediate barrier 66 and outer barrier 68 at ceiling 46 of dome 44. This region becomes a third debris pocket 106. Passing along second passageway 92 toward third apertures 88, debris entrained in inflation gas is driven into a fourth debris pocket 108 between intermediate barrier 66 and outer barrier 68 at base 42. The inflation gas veers through third apertures 88 and drives remaining debris against the solid inner surface 62 of sidewall 48 of dome 44. The debris either adheres there or migrates into a relatively sheltered fifth debris pocket 110 between outermost barrier 68 and sidewall 48 of dome 44 at base 42. Then, traveling along third passageway 94 inflation gas veers in another ninety-degree turn to escape from inflator 30 through exit ports 50. The remaining momentum carries that debris upward as seen in FIG. 5 into a sixth debris pocket 112 between outer barrier 68 and inner surface 62 of sidewall 48 at ceiling 46.

Thus, according to teachings of the present invention, it is efficacious to remove entrained debris from a stream of inflation gas leaving an inflator by forcing the inflation gas into several sharp turns, such as turns of 90 degrees, prior to allowing the inflation gas to exit the inflator. Each of these turns drops successively more and possibly finer entrained debris along the pathway of the escaping inflation gas. The debris separated from the escaping inflation gas collects in debris pockets that are also afforded by teachings of the present invention. The result is a flow of inflation gas in opposite directions in a series of closely adjacent passageways. Also relevant to the effectiveness of the filtering process is the substantially perpendicular impact of escaping inflation gas against solid barriers where the debris may adhere or lose a sufficient amount of momentum as to drop out of the inflation gas and migrate to an adjacent debris pocket. Thus, the mechanisms operate as a filter according to teachings of the present invention differ from the mechanisms that operate as a filter that obscures the effective fluid flow cross section for inflation gas with layers of a finely porous or a fibrous material. In apparatus and methods of the present invention, the outflow of inflation gas is abruptly redirected on numerous occasions during its passageway out of the inflator in which it was generated.

As used herein, barriers in a filter configured according to teachings of the present invention may for convenience be described as being generally parallel to each other, even when the barriers, like the barriers of filter 56, are actually coaxially disposed. It should be understood that although a coaxial disposition of the barriers is preferred, one or more of the barriers may be disposed eccentrically to provide a slightly different effect that may be desirable. In addition, selected portions of cylindrical barriers in a filter configured according to teachings of the present invention may also for convenience be described as being planar.

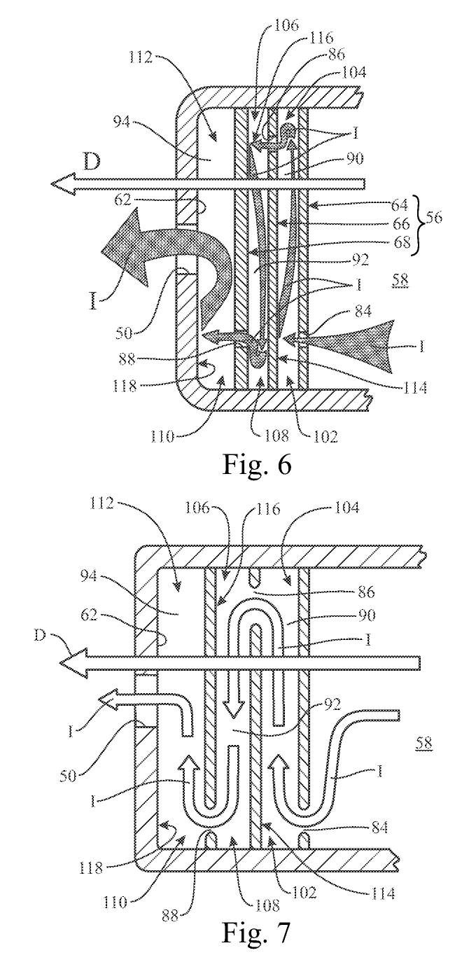

FIG. 6 depicts in diagrammatic form the tortuous pathway undertaken by inflation gas I traveling through a filter, such as filter 56. In leaving combustion chamber 58, inflation gas I passes through first aperture 84 in inner barrier 64 and is driven directly against a solid surface of intermediate barrier 66 at first impact site 114. There the momentum of entrained debris tends to separate the entrained debris from the flow of inflation gas I. Thusly, disentrained debris may adhere to first impact site 114 or migrate therefrom into first debris pocket 102. Inflation gas I then travels the length of first passageway 90, depositing additional entrained debris in second debris pocket 104 before passing through second apertures 86 and being driven directly at a solid surface of outer barrier 68 at second impact site 116. The momentum of entrained debris is spent against outer barrier 68. Additional particles of debris adhere at second impact site 116 or migrate out of the flow of inflation gas into third debris pocket 106. Inflation gas then travels the length of second passageway 92 reversing direction at fourth debris pocket 108 and depositing more debris there before escaping through outer barrier 68 by way of third apertures 88. Inflation gas I is driven directly against inner surface 62 of sidewall 48 of inflator 30 at third impact site 118, where the momentum of remaining entrained debris is further expended. Debris either adheres to inner surface 62 of sidewall 48 or migrates out of the flow of inflation gas I into fifth degree pocket 110. Remaining entrained debris passes along third passageway 94 toward ceiling 46 of dome 44 of inflator 30 into a sixth debris pocket 112, while inflation gas I veers through exit ports 50.

FIG. 7 illustrates these relationships among the functional features of a filter configured according to teachings of the present invention and the complex pathway of fluid flow undertaken by pressurized inflation gas inflator in which the inflation gas is produced. In FIG. 7 primarily apertures, passageways, debris pockets, and impact sites are identified.

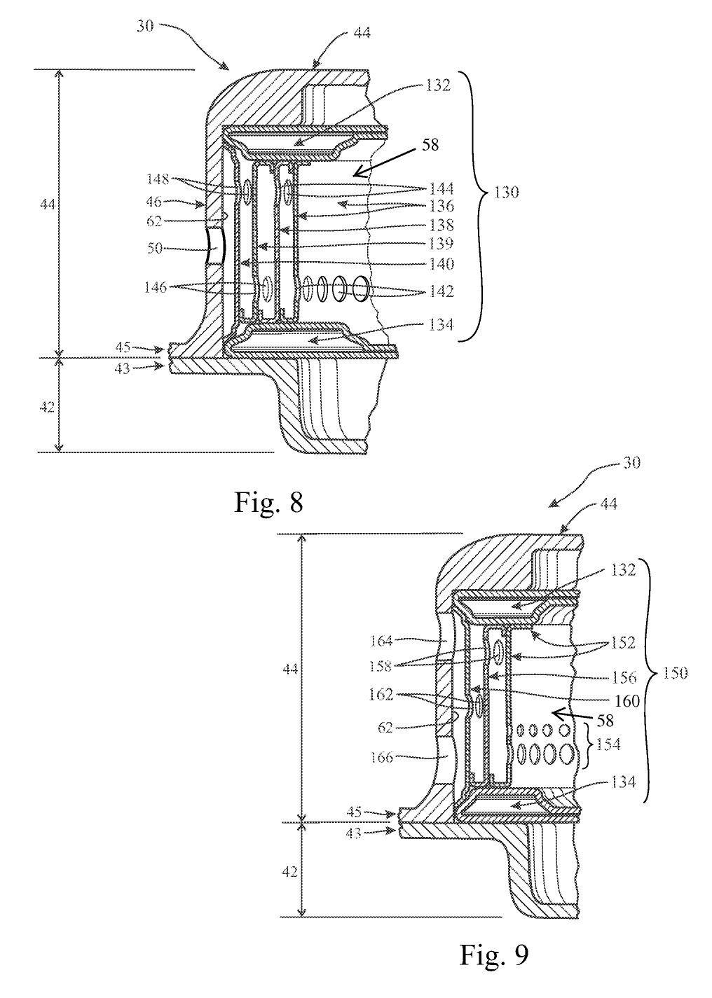

FIG. 8 is a cross-sectional elevation view of a second embodiment of a filter 130 incorporating teachings of the present invention. In forming filter 130, a plurality of parallel-disposed barriers are secured by welding or other appropriate means, between a hollow upper support ring 132 and an opposed hollow lower support ring 134. In the alternative, rings such as upper support ring 132 and lower support ring 134 may be solid structures. Moving radially outwardly from combustion chamber 58, attached between upper support ring 132 and lower support ring 134 are a first barrier 136, a second barrier 138, a third barrier 139, and a fourth barrier 140. A plurality of first apertures 142 are formed through first barrier 136 proximate to an edge thereof, while a plurality of second apertures 144 are formed through second barrier 138 at an edge thereof that is remote first apertures 142. A plurality of third apertures 146 are formed through third barrier 139 at an edge thereof remote from second apertures 144, and a plurality of fourth apertures 148 are formed through an edge of fourth barrier 140 remote from third apertures 146.

FIG. 9 is a cross-sectional elevation view of a third embodiment of a filter 150 incorporating teachings of the present invention. The barriers of filter 150 are disposed between upper support ring 132 and lower support ring 134. A first barrier 152 with a plurality of paired large and small first apertures 154 formed therethrough is the innermost of the barriers of filter 150. A second barrier 156 is positioned radially outwardly of first barrier 152 with a plurality of second apertures 158 formed therethrough at an edge thereof remote from first apertures 154. A third barrier 160 positioned radially outwardly of second barrier 156 has a plurality of third apertures 162 formed therethrough a medial portion thereof (i.e., generally equidistant from the ends of the third barrier 160). The location of third apertures 162 is calculated to cause inflation gas leaving filter 150 by way of third apertures 162 to impact inner surface 62 of sidewall 48 intermediate first exit port 164 and second exit port 166 of inflator 30 that are formed through the opposed ends of sidewall 48.

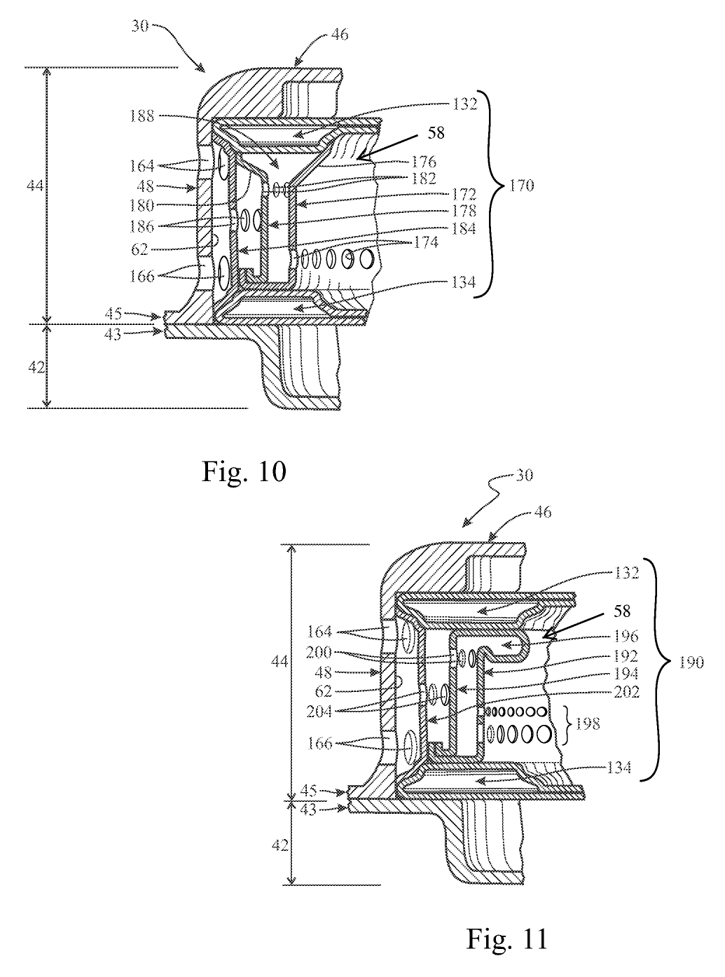

FIG. 10 is an elevational cross section view of a fourth embodiment of a filter 170 incorporating teachings of the present invention. Opposed upper support ring 132 and lower support ring 134 secure therebetween a first barrier 172 having a first set of apertures 174 formed through one end thereof and a first flange portion 176 at the opposite end thereof. A second barrier 178 disposed radially outwardly from first barrier 172 has a second flange portion 180 that is positioned adjacent to first flange portion 176 of first barrier 172. A plurality of second apertures 182 are formed through second barrier 178 adjacent to second flange portion 180. Radially outermost, a third barrier 184 includes a plurality of third apertures 186 formed therethrough at a medial location. The space between second flange portion 180 of second barrier 178 and first flange portion 176 of first barrier 172 creates an enlarged debris pocket 188 having ample space in which to shelter debris from continued entrainment in inflation gas.

FIG. 11 is a cross-sectional elevation view of a fifth embodiment of a filter 190 embodying teachings of the present invention. In filter 190, an inner barrier 192 and a medial barrier 194 are advantageously fabricated from a single thin sheet folded upon itself. Accordingly, between inner barrier 192 and medial barrier 194 a lobed debris pocket 196 arises that is highly effective in capturing debris. A plurality of paired large and small first apertures 198 are formed through the end of inner barrier 192 opposite from lobed debris pocket 196, while a plurality of second apertures 200 are formed through medial barrier 194 adjacent to lobed debris pocket 196. An outer barrier 202 includes a plurality of third apertures 204 formed therethrough a medial location.

The present invention also includes associated methods for removing entrained debris from pressurized inflation gas before that inflation gas enters the cushion of an airbag module.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A filter element comprising a plurality of substantially parallel-disposed barriers affording fluid communication between a source of pressurized airbag inflation gas containing entrained particulates and an airbag inflation gas entry port along a tortuous path of back-and-forth oppositely-directed gas flow pathways between successive pairs of adjacent of the barriers.

2. A filter element as recited in claim 1, further comprising an aperture formed through each of the barriers, the barriers being so arranged that the aperture in a selected barrier is remote from the aperture in any barrier adjacent thereto.

3. A filter element as recited in claim 1, further comprising a debris pocket at an end of a gas flow pathway, the debris pocket being so configured that particulates entrained in inflation gas traveling to the entry port collect in the debris pocket sheltered from sustained entrainment in the inflation gas.

4. A filter for an airbag module inflator, the filter comprising a plurality of cylindrical barriers of increasing diameter secured at the opposed ends thereof within the inflator in a narrowly-spaced coaxial relationship about the combustion chamber of the inflator, each of the barriers having formed therethrough proximate to a preselected end thereof a plurality of apertures with the barriers being so arranged that the apertures in a selected barrier are remote from the apertures in any barrier adjacent thereto, thereby requiring inflation gas from the combustion chamber in traveling to an outlet port of the inflator to follow a tortuous path comprising oppositely-directed gas flow pathways between adjacent pairs of the barriers.

5. A filter as recited in claim 4, further comprising a debris pocket at an end of a gas flow pathway, the debris pocket being so configured that particulates entrained in inflation gas traveling to the outlet port collect in the debris pocket sheltered from sustained entrainment in the inflation gas.

6. A filter as recited in claim 4, wherein inflation gas traveling through the apertures in the radially-outermost of the barriers is directed into a perpendicular impact against the interior of the inflator at a location other than the location of a discharge port of the inflator.

7. A filter as recited in claim 6, wherein the apertures in the radially-outermost of the barriers are formed there through substantially equidistant from the opposed ends thereof.

8. A filter for removing debris from inflation gas pyrotechnically generated in the combustion chamber of the inflator of a passenger vehicle safety airbag module, the inflator having a discharge port through which inflation gas flows into the cushion of the airbag module, the filter comprising:
(a) a first barrier secured within the inflator across the flow of inflation gas from the combustion chamber to the discharge port, the first barrier having a first aperture formed therethrough proximate to an edge thereof;
(b) a second barrier having a second aperture formed therethrough proximate to an edge thereof, the second barrier being secured within the inflator across the flow of inflation gas from the first aperture to the discharge port with the second aperture disposed remote from the first aperture; and
(c) a third barrier having a third aperture formed therethrough, the third barrier being secured within the inflator across the flow of inflation gas from the second aperture to the discharge port with the third aperture disposed remote from the second aperture.

9. A filter as recited in claim 8, wherein the third aperture is formed through the third barrier proximate to an edge thereof.

10. A filter as recited in claim 8, wherein the first barrier, the second barrier, and the third barrier each comprises a respective wall of sheet metal.

11. A filter as recited in claim 8, wherein the first barrier, the second barrier, and the third barrier each comprises a respective cylindrical wall secured at the open ends thereof within the inflator enclosing the combustion chamber.

12. A filter as recited in claim 11, wherein first barrier, the second barrier, and the third barrier are coaxially disposed about the combustion chamber.

13. A filter as recited in claim 8, wherein:
(a) a first passageway is defined between the first barrier and the second barrier, the first passageway for allowing inflation gas to flow from the first aperture to the second aperture; and
(b) a second passageway is defined between the second barrier and the third barrier, the second passageway for allowing inflation gas to flow in a direction opposite to the flow of inflation gas in the first passageway from the second aperture to the third aperture.

14. A filter as recited in claim 13, wherein an end of the first passageway proximate the second aperture is formed into a first debris collection pocket.

15. A filter as recited in claim 13, wherein an end of the second passageway proximate the third aperture is formed into a second debris collection pocket.

16. A filter as recited in claim 8, wherein inflation gas flowing through the first aperture is directed substantially normal to a surface of the second barrier.

17. A filter as recited in claim 8, wherein inflation gas flowing through the second aperture is directed substantially perpendicular to a surface of the third barrier.

18. A filter as recited in claim 8, wherein inflation gas flowing through the third aperture is directed normal to the interior of the inflator at a location other than the location of the discharge port.

19. An inflator for a passenger vehicle safety airbag module, the inflator comprising:
(a) a casing enclosing a combustion chamber;
(b) an exit port formed through the casing; and
(c) filter for removing debris from inflation gas pyrotechnically generated in the combustion chamber, the filter comprising a plurality of cylindrical barriers of increasing diameter secured at the opposed ends thereof within the casing in a narrowly-spaced coaxial relationship about the combustion chamber, each of the barriers having formed therethrough proximate to a preselected end thereof a plurality of apertures with the barriers being so arranged that the apertures in a selected barrier are remote from the apertures in any barrier adjacent thereto, thereby requiring inflation gas from the combustion chamber in traveling to the outlet port to follow a tortuous path comprising oppositely-directed gas flow pathways between adjacent pairs of the barriers.

20. A filter as recited in claim 19, further comprising a debris pocket at an end of a gas flow pathway, the debris pocket being so configured that particulates entrained in inflation gas traveling to the outlet port collect in the debris pocket sheltered from sustained entrainment in the inflation gas.

21. A filter as recited in claim 19, wherein inflation gas traveling through the apertures in the radially-outermost of the barriers is directed into a substantially perpendicular impact against the interior of the casing at a location other than the location of a discharge port.

22. A method for removing debris from pressurized inflation gas generated in the combustion chamber of the inflator of a passenger vehicle safety airbag module, the method comprising the steps:
(a) encircling the combustion chamber of the inflator with a plurality of cylindrical barriers of increasing diameter disposed in a narrowly-spaced relationship with each other;
(b) forming through each of the barriers proximate to a preselected end thereof a plurality of apertures;
(c) securing the barriers at the opposed ends thereof within the inflator; and
(d) arranging the barriers in such a manner that the apertures in a selected barrier are remote from the apertures in any barrier adjacent thereto.

23. A method as recited in claim 22, further comprising the step positioning a discharge port for the inflator in such a location that inflation gas traveling through the apertures in the radially-outermost of the barriers is directed into a substantially perpendicular impact against the interior of the inflator at a location other than the location of the discharge port.
